(19) United States
(12) Patent Application Publication
(10) Pub. No.: US 2017/0228719 A1
(43) Pub. Date: Aug. 10, 2017

(54) PAYMENT HANDLING APPARATUS AND METHOD

(71) Applicant: COMCARDE LIMITED, Inverness Highland (GB)

(72) Inventors: Stuart JAMIESON, Inverness Highland (GB); James GOODMAN, Inverness Highland (GB); Keith SYMINGTON, Inverness Highland (GB)

(21) Appl. No.: 15/329,024

(22) PCT Filed: Aug. 4, 2015
(86) PCT No.: PCT/GB2015/052257

§ 371 Date: Jan. 25, 2017

(30) Foreign Application Priority Data
Aug. 5, 2014 (GB) 1413834.1

(51) Int. Cl. G06Q 20/32; G06Q 20/40

(52) U.S. Cl. CPC G06Q 20/3221; G06Q 20/3276; G06Q 20/401

(57) ABSTRACT

The present invention relates to payment handling apparatus (10) which is operable to effect payment from a purchaser to a vendor. The payment handling apparatus comprises a purchaser client (12) operable by the purchaser, a vendor client (16) operable by the vendor and a purchaser server (14) which stores bank account information of the purchaser and which is in data communication with the purchaser client. The payment handling apparatus (10) also comprises a vendor server (18) which stores bank account information of the vendor and which is in data communication with the vendor client (16) and the purchaser server (14). The payment handling apparatus (10) is configured such that there is no data communication between the purchaser server (14) and the vendor client (16) and between the vendor server (18) and the purchaser client (12). The purchaser client (12) is operative in dependence on purchaser operation to receive a unique code from the purchaser server 14. The vendor client (16) is operative in dependence on vendor operation to communicate the unique code and a sum to be paid to the vendor server (18). The purchaser and vendor servers (14, 18) are data communication to effect payment of the sum from the purchaser's bank account to the vendor's bank account in dependence on the unique code.

### FIELD OF THE INVENTION

The present invention relates to payment handling apparatus which is operable to effect payment from a purchaser to a vendor. The present invention also relates to a payment handling method which effects payment from a purchaser to a vendor.

### BACKGROUND ART

Arrangements for making payments by way of a mobile device are known. According to one longer used approach, the vendor has apparatus comprising a handheld device such as a smartphone and a credit/debit card reader. The handheld device and the credit/debit card reader are in data communication and normally wireless data communication with each other such as by way of Bluetooth. Payment for goods or services is accomplished by the vendor entering the transaction details including the cost of the goods or services into the apparatus before the purchaser's credit/debit card is read by the credit/debit card reader and the purchaser authorises payment by entering a PIN associated with the credit/debit card.

More recently approaches to making payments without operative use of a credit/debit card have been introduced. One such approach involves the purchaser entering credit/debit card data into the vendor's mobile device or into a client process running on the purchaser's device which is controlled over the Internet by a vendor process. This approach relies on underlying card payment infrastructure. A disadvantage of this approach is the storage by the vendor of the purchaser's banking details. A further known approach avoids this disadvantage. The further known approach involves the purchaser logging into his banking application before the vendor passes a code containing payment details including the vendor's banking details to the purchaser. The purchaser then enters the code into the banking application which is then operative by way of data communication with the vendor's bank server to effect payment to the vendor such as by way of a faster Automated Clearing House (ACH) payment.

The present inventors have appreciated the above described known approaches to present a data security risk even in the case of the further approach where the purchaser's banking application (or client) rather than the vendor's banking application (or client) holds banking details. The present invention has been devised in the light of this appreciation. It is therefore an object for the present invention to provide improved payment handling apparatus which is operable to effect payment from a purchaser to a vendor. It is a further object for the present invention to provide an improved payment handling method which effects payment from a purchaser to a vendor.

### STATEMENT OF INVENTION

According to a first aspect of the present invention there is provided payment handling apparatus which is operable to effect payment from a purchaser to a vendor, the payment handling apparatus comprising:
a purchaser client operable by the purchaser;
a vendor client operable by the vendor;
a purchaser server which stores bank account information of the purchaser and which is in data communication with the purchaser client; and
a vendor server which stores bank account information of the vendor and which is in data communication with the vendor client and the purchaser server,
the payment handling apparatus being configured such that there is no data communication between the purchaser server and the vendor client and between the vendor server and the purchaser client,
the purchaser client being operative in dependence on purchaser operation to receive a unique code from the purchaser server,
the vendor client being operative in dependence on vendor operation to communicate the unique code and a sum to be paid to the vendor server,
the purchaser and vendor servers being in data communication to effect payment of the sum from the purchaser's bank account to the vendor's bank account in dependence on the unique code.

The payment handling apparatus comprises a purchaser client which is operable by the purchaser, a vendor client which is operable by the vendor, a purchaser server which stores bank account information of the purchaser and which is in data communication with the purchaser client and a vendor server which stores bank account information of the vendor and which is in data communication with the vendor client and the purchaser server.

The payment handling apparatus is configured such that there is no data communication between the purchaser server and the vendor client and between the vendor server and the purchaser client. More specifically there may be no direct data communication between the purchaser server and the vendor client and between the vendor server and the purchaser client. There may, for example, be data communication between the vendor server and the purchaser client by way of the purchaser server. By way of another example there may be data communication between the purchaser server and the vendor client by way of the vendor server. Therefore the payment handling apparatus may be configured such that there is data communication between the purchaser client and the vendor client only by way of the purchaser server and the vendor server. This is contrast with the further approach described above which involves the purchaser logging into his banking application before the vendor passes a code representing the transaction to the purchaser and thereafter the purchaser enters the code into the banking application which is then operative by way of direct data communication with the vendor's bank server to effect payment to the vendor. According to this further approach, there is direct data communication between the purchaser's banking application (i.e. the purchaser client) and the vendor's bank server (i.e. the vendor server). Direct data communication between the purchaser client and vendor server may present a data security risk which is avoided by way of the present invention. Alternatively or in addition the payment handling apparatus may be configured such that there is no data communication of bank account information between the purchaser server and the vendor client and between the vendor server and the purchaser client. Payment handling apparatus configured in this fashion may not preclude the communication of data which does not relate to bank account information or the unique code between the purchaser server and the vendor client and between the vendor server and the purchaser client.

In use, the purchaser client is operative in dependence on purchaser operation to receive a unique code from the purchaser server. There may therefore be no need to store bank account information of the purchaser in the purchaser client with the bank account information being stored in the purchaser server. The payment handling apparatus may therefore be configured such that bank account information of the purchaser is stored in the purchaser server only of the purchaser client and the purchaser server. This is in contrast to the like of the known approach in which the purchaser logs into his banking application. Lack of bank account information being stored in the purchaser client may reduce the risk of a data security breach. In many circumstances data communication between a client and a server presents a greater security risk compared, for example, with data communication between two servers.

The vendor client is operative in dependence on vendor operation to communicate the unique code and a sum to be paid to the vendor server whereupon the purchaser and vendor servers are in data communication to effect payment of the sum from the purchaser's bank account to the vendor's bank account in dependence on the unique code. There may therefore be no need to store bank account information of the vendor in the vendor client with bank account information being stored in the vendor server. The payment handling apparatus may therefore be configured such that bank account information of the vendor is stored in the vendor server only of the vendor client and the vendor server. There may be no need to store bank account information of the purchaser in the vendor client. The bank account information of the purchaser may thus be stored in the purchaser server only of the purchaser server and vendor client and more specifically of the purchaser server, vendor client and the purchaser client. This is in contrast with known approaches in which the bank account information of the purchaser in the form of credit card data is entered and then stored in the vendor client, for example, by a credit/debit card reader comprised in vendor apparatus. The bank account information of the purchaser may be stored in the purchaser server only of the purchaser server, the vendor client, the purchaser client and the vendor server. The storing of bank account information of the purchaser in particular on the vendor server over an extended period can present a security risk in the face of attempts by hackers to gain access to a vendor's server or to the like of a payment processor's server.

The purchaser client is operative in dependence on purchaser operation to receive a unique code from the purchaser server. When the purchaser is ready to make payment he operates the purchaser client, such as by way of his mobile device, to receive the unique code from the purchaser server. Thereafter the vendor client is operative in dependence on vendor operation to communicate the unique code and the sum to be paid to the vendor server. The payment process is therefore purchaser initiated. This is in contrast with known approaches in which the payment process is vendor initiated. For example the further known approach described above involves the vendor passing a code representing the transaction to the purchaser. A purchaser initiated approach may give the purchaser more control over the payment process and enable the purchaser to make a more considered decision as whether or not to purchase by, for example, giving him the opportunity to check his bank balance before committing to the payment process. By way of a further example, a purchaser initiated approach may give the purchaser the opportunity to apply a discount code, provide loyalty card information or the like as is described below in more detail.

The payment handling apparatus may be configured such that the purchaser client is operative to send a unique code request to the purchaser server in dependence on purchaser operation. The purchaser may, for example, operate an application resident on his mobile device to thereby cause the application to send a unique code request to the purchaser server. Upon receipt of the unique code request the purchaser server may be operative to generate a unique code and to send the unique code to the purchaser client. The unique code may then be conveyed to the vendor client. More specifically and according to a first approach the purchaser may himself convey the unique code to the vendor himself, for example verbally, who may then enter the unique code into the vendor client. The purchaser client may, for example, be operative to display the unique code. The purchaser may read the displayed unique code and verbally convey the unique code to the vendor before the vendor enters the read unique code into the vendor client such as by way of a touch keypad. The like of a discount code or loyalty card information may be received by and acted upon by the vendor client in accordance with conventional practice by, for example, the vendor scanning a barcode comprising the discount code or loyalty card information.

Alternatively or in addition and according to a second approach, the purchaser client may be operative to provide the unique code to the vendor by electronic means. The purchaser client and the vendor client may be configured for electronic communication of the unique code from the purchaser client to the vendor client. More specifically the purchaser client may be operative such that the unique code is comprised in electronically stored data. The electronically stored data may then be conveyed to the vendor by electronic means. According to one approach, the purchaser client may be operative to form a barcode, such as a QR code, comprising the unique code. The purchaser client may be operative to display the barcode, for example on a display screen comprised in the purchaser's smartphone. The displayed barcode may then be received by the vendor client in dependence on the vendor client being operative to scan the barcode, for example by way of a barcode scanner comprised in vendor apparatus. According to another approach, the purchaser client may be operative to provide for near field communication of the electronically stored data to the vendor. The purchaser client may comprise near field communication transceiver apparatus. The vendor client may comprise near field communication transceiver apparatus. The near field communication transceiver apparatus may provide for radio frequency communication of the electronically stored data from the purchaser client to the vendor client.

The electronically stored data may comprise marketing information such as a discount code, loyalty card information or the like. Scanning of the barcode or near field communication of the electronically stored data may therefore upload the marketing information in addition to the unique code. The vendor client may be operative to process the marketing information in accordance with known practice, such as in respect of accumulation of reward points or the application of a discount to the sale price. The purchaser client may be operative to store the marketing information. More specifically the purchaser client may be operative to store marketing information for plural different vendors. The purchaser client may be operative to select marketing information for one of the plural different vendors. The purchaser client may be operative to select the marketing information in dependence on wireless reception from the vendor, such as WiFi reception from a WiFi transceiver present in the vendor's premises. The wireless reception may provide for determination of the identity of the vendor and in dependence on determination of the identity of the present vendor for selection of the present vendor's marketing information from the stored marketing information.

As described above the vendor client is operative in dependence on vendor operation to communicate the unique code and the sum to be paid to the vendor server. In addition the vendor client may be operative to communicate vendor identification information to the vendor server along with the unique code and the sum to be paid. The vendor identification information may comprise a name for the vendor. Alternatively or in addition the vendor identification information may comprise a logo for the vendor. The vendor identification information may provide a level of security further to the unique code. As will become apparent from the following description, use of the vendor identification information may allow the purchaser to authenticate the transaction. Where the vendor identification information comprises a logo for the vendor, the logo may provide for ready visual authentication by the purchaser.

As described above the purchaser and vendor servers are in data communication to effect payment of the sum from the purchaser's bank account to the vendor's bank account in dependence on the unique code. The vendor server may be operative to send a request to pay message to the purchaser server. The request to pay message may comprise the unique code and the sum to be paid. Where vendor identification information is received by the vendor server from the vendor client, the request to pay message may further comprise the vendor identification information. The request to pay message may further comprise bank information for the vendor such as at least one of the sort code, the account number and the account name. Upon receipt of the unique code comprised in the request to pay message the purchaser server may be operative to match the unique code comprised in the request to pay message with the unique code generated in response to the unique code request. A positive match between the two unique codes may serve at least in part for authentication of the request to pay message. Payment of the sum from the purchaser's bank account to the vendor's bank account may therefore be effected in dependence on a positive match between the two unique codes. The purchaser server may also be operative to compare the sum to be paid with a balance in the purchaser's bank account. Authentication of the request to pay message may depend on there being sufficient funds in the purchaser's bank account to cover the transaction. Payment of the sum from the purchaser's bank account to the vendor's bank account may be, for example, by way of a BACs or SWIFT transaction. As described below, payment processing may also or alternatively depend on purchaser approval of the transaction.

The purchaser server may be operative to send a request to pay message to the purchaser client. The request to pay message sent to the purchaser client may comprise the sum to be paid and vendor identification information. The purchaser client may be operative to display the request to pay message to the purchaser. The purchaser may thus see the vendor identification information comprised in the request to pay message and perhaps also the sum to be paid and thereby allow the purchaser to approve the purchase. The purchaser may approve the purchase by operation of the purchaser client. The purchaser client may send a payment approved message to the purchaser server in dependence on such operation of the purchaser client by the purchaser. Alternatively or in addition the purchaser server may send a payment approved message to the vendor server in dependence on receipt of the payment approved message from the purchaser client. Where the sum to be paid is below a predetermined level, such as no more than £20, there may be no approval by the purchaser whereby authentication and approval is solely by the purchaser server of the purchaser server and the purchaser client. The payment handling apparatus may be configured to select whether or not there is purchaser client approval. More specifically the purchaser server may be operative to determine whether or not there is to be purchaser client approval in dependence on comparison of the sum to be paid with a predetermined figure.

After payment of the sum from the purchaser's bank account to the vendor's bank account has been effected, the payment handling apparatus may be operative to terminate the unique code. More specifically the unique code may be designated as expired whereby a message comprising the terminated unique code is not acted upon. Alternatively the unique code may be deleted whereby a message comprising the now deleted unique code is not acted upon. The unique code may therefore exist for a comparatively short period of time and may thus present a reduced risk for breach of data security. This is in stark contrast to known approaches, such as payment processor approaches, in which purchasers' bank account details are stored for considerable periods of time. After payment of the sum from the purchaser's bank account to the vendor's bank account has been effected, the purchaser server may be operative to send a payment complete message to the vendor server. The purchaser payment complete message may comprise the unique code and the amount paid. In addition the payment complete message may comprise at least one of the purchaser's name and the vendor's name.

Alternatively or in addition, after payment of the sum from the purchaser's bank account to the vendor's bank account has been effected the vendor server may be operative to send a vendor payment confirmed message to at least one of: the purchaser server; the vendor client; and the purchaser client by way of the purchaser server. The vendor payment complete message may comprise a vendor server unique code and the amount paid. In addition the vendor payment complete message may comprise the unique code. The vendor server may be operative to generate the vendor server unique code.

The unique code may be alphanumeric. The unique code may lack at least one of the letters O, I, Q and Z. Such letters may be liable to confusion with other alphanumeric characters. The unique code may be at least five alphanumeric characters long. The length of the unique code may be a compromise between a requirement for uniqueness and ease of handling by the payment handling apparatus, the purchaser and the vendor. For example in smaller territories in which the payment handling apparatus is operative a shorter unique code may suffice to achieve uniqueness whereas in larger territories a longer unique code may be required.

The payment handling apparatus may comprise plural purchaser clients. In a typical application the payment handling apparatus may comprise many purchaser clients at any one time. Payment may be effected in respect of each of the plural purchaser clients at the same time. At different times payment may be effected in respect of different purchaser servers and different vendor servers. The identity of a purchaser server or a vendor server may depend on the identity of the payment handling establishment engaged by the purchaser or vendor. For example one purchaser may engage a first bank and another purchaser may engage a second bank. Indeed the payment handling apparatus may be configured such that each of plural purchasers or vendors engages a different payment handling establishment at any one time. By way of further example the payment handling establishment may be a clearing bank, a credit/debit card handling establishment, the like of PayPal, etc. At least one of the purchaser server and the vendor server may comprise the payment handling establishment. The payment handling establishment may, for example, be a credit card handling establishment such that payment is made on behalf of the purchaser with actual settlement of the sum being paid by the purchaser at a later time. The purchaser server and the vendor server being in data communication to effect payment in dependence on the unique code may be such that, in use, at least one step is taken towards making payment. The payment handling apparatus may comprise at least one of plural purchaser servers and plural vendor servers. Where the payment handling apparatus comprises client apparatus and server apparatus the client apparatus and server apparatus may be at locations spaced apart from each other. Where the payment handling apparatus comprises purchaser server apparatus and vendor server apparatus, the purchaser server apparatus and the vendor server apparatus may be at locations spaced apart from each other.

At least one of the purchaser client and the vendor client may be operable on client apparatus. The payment handling apparatus may comprise at least one such client apparatus. A client may be operable on at least one of a Personal Computer, such as a laptop, and a mobile computing device, such as a tablet computer or a smartphone. At least one of the purchaser server and the vendor server may be operable on server apparatus. The payment handling apparatus may comprise at least one such server apparatus.

The purchaser and the vendor may engage the same payment handling establishment, for example the same bank. The purchaser server and the vendor server may therefore be comprised in the same server apparatus. Server apparatus may be distributed such that a purchaser related process is operative on a first part of the server apparatus and a vendor related process is operative on a second part of the server apparatus. Indeed a purchaser or server related process may be operative on different parts of server apparatus at different times. Alternatively or in addition, first and second parts of a purchaser or server related process may be operative on different parts of server apparatus during the course of effecting payment of one sum from the purchaser's bank account to the vendor's bank account.

A server, for example the purchaser server or the vendor server may comprise a server application. Where communication is by way of the Internet the server application may comprise a web server. A client, for example the purchaser client or the vendor client, may be configured to run a client application. Where communication is by way of the Internet the client application may comprise a web client. The purchaser application may be operative to provide the functions and operations described above. Communication between a client and a server may be by way of at least one of: a computer network, such as the Internet; and a metropolitan or wide area network, such as the Global System for Mobile Communications (GSM) network or 4G. Communication between the purchaser server and the vendor server may be by way of a communications link, for example a dedicated communications link or a computer network, such as the Internet. A client, for example the purchaser client or the vendor client, may be configured to provide a dialog box. The dialog box may be a web browser window. The dialog box may be displayed on a display surface of client apparatus, such as a display screen of a mobile computing device. The dialog box may provide for reciprocal communication between a client process and a user. The dialog box may comprise at least one user operable component, such as a clickable or touch sensitive area, which is operative to provide for entry of data and control by a user.

According to a second aspect of the present invention there is provided a payment handling method which effects payment from a purchaser to a vendor, the method comprising:
receiving in a purchaser client a unique code from a purchaser server in dependence on operation of the purchaser client by the purchaser, the unique code being received by way of data communication between the purchaser client and the purchaser server, the purchaser server storing bank account information of the purchaser;
communication of the unique code and a sum to be paid from a vendor client to a vendor server in dependence on operation of the vendor client by the vendor, the unique code and the sum to be paid being communicated by way of data communication between the vendor client and the vendor server, the vendor server storing bank account information of the vendor; and
effecting payment of the sum from the purchaser's bank account to the vendor's bank account in dependence on the unique code and by way of data communication between the purchaser and vendor servers, there being no data communication between the purchaser server and the vendor client and between the vendor server and the purchaser client.

Embodiments of the second aspect of the present invention may comprise one or more features of the first aspect of the present invention.

According to a third aspect of the present invention there is provided a computer program comprising program instructions for causing computer apparatus to perform the method according to the second aspect of the present invention. More specifically, the computer program may be at least one of: embodied on a record medium; embodied in read only memory; stored in a computer memory; and carried on an electrical carrier signal. Further embodiments of the third aspect of the present invention may comprise one or more features of the first aspect of the present invention.

According to a fourth aspect of the present invention there is provided a computer system comprising program instructions for causing computer apparatus to perform the method according to the second aspect of the present invention. More specifically the program instructions may be at least one of: embodied on a record medium; embodied in a read only memory; stored in a computer memory; and carried on an electrical carrier signal. Further embodiments of the fourth aspect of the present invention may comprise one or more features of the first aspect of the present invention.

According to a further aspect of the present invention there is provided payment handling apparatus which is operable to effect payment from a purchaser to a vendor, the payment handling apparatus comprising: a purchaser client operable by the purchaser; a vendor client operable by the vendor; a purchaser server which stores bank account information of the purchaser and which is in data communication with the purchaser client; and a vendor server which stores bank account information of the vendor and which is in data communication with the vendor client and the purchaser server, the purchaser client being operative in dependence on purchaser operation to receive a unique code from the purchaser server, the vendor client being operative in dependence on vendor operation to communicate the unique code and a sum to be paid to the vendor server, the purchaser and vendor servers being in data communication to effect payment of the sum from the purchaser's bank account to the vendor's bank account in dependence on the unique code. Embodiments of the further aspect of the present invention may comprise one or more features of the first aspect of the present invention.

### BRIEF DESCRIPTION OF DRAWINGS

Further features and advantages of the present invention will become apparent from the following specific description, which is given by way of example only and with reference to the accompanying drawings, in which:

FIG. 1 is a block diagram representation of payment handling apparatus according to the present invention; and

FIGS. 2A to 2H represent the main stages of operation of the payment handling apparatus of FIG. 1.

### DESCRIPTION OF EMBODIMENTS

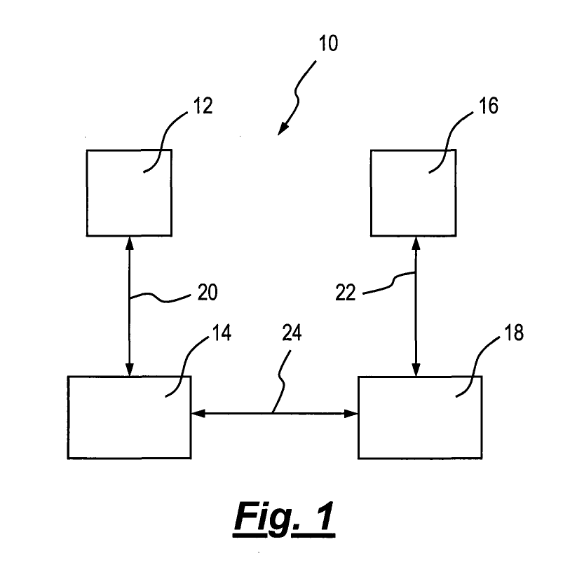

A block diagram representation of payment handling apparatus 10 according to the present invention is shown in FIG. 1. The payment handling apparatus 10 comprises a purchaser client 12, a purchaser server 14, a vendor client 16 and a vendor server 18. The purchaser client 12 is a process operative on mobile computing apparatus owned by a purchaser, such as a tablet computer or more typically a smartphone. The vendor client 16 is a process operative on computing apparatus owned by a vendor, such as a laptop computer, a tablet computer or a PC based till. The purchaser server 14 is comprised in purchaser server apparatus operated by a payment processing authority such as a bank. Typically the purchaser server apparatus has a distributed architecture. Likewise the vendor server 18 is comprised in vendor server apparatus operated by a payment processing authority such as a bank. Again the vendor server apparatus typically has a distributed architecture. Communication of data between the purchaser client 12 and the purchaser server 14 is by way of a computer network 20, such as the Internet or a metropolitan or wide area network 20, such as the Global System for Mobile Communications (GSM) or 4G network. Likewise communication of data between the vendor client 16 and the vendor server 18 is by way of a computer network 22, such as the Internet, or a metropolitan or wide area network 22, such as the Global System for Mobile Communications (GSM) or 4G network. Communication between the purchaser server 14 and the vendor server 18 is by way of a communications link 24, for example a dedicated communications link or a computer network, such as the Internet. Under certain circumstances a dedicated communications link is preferred on account of the greater level of security afforded in comparison to a more open Internet based communications link.

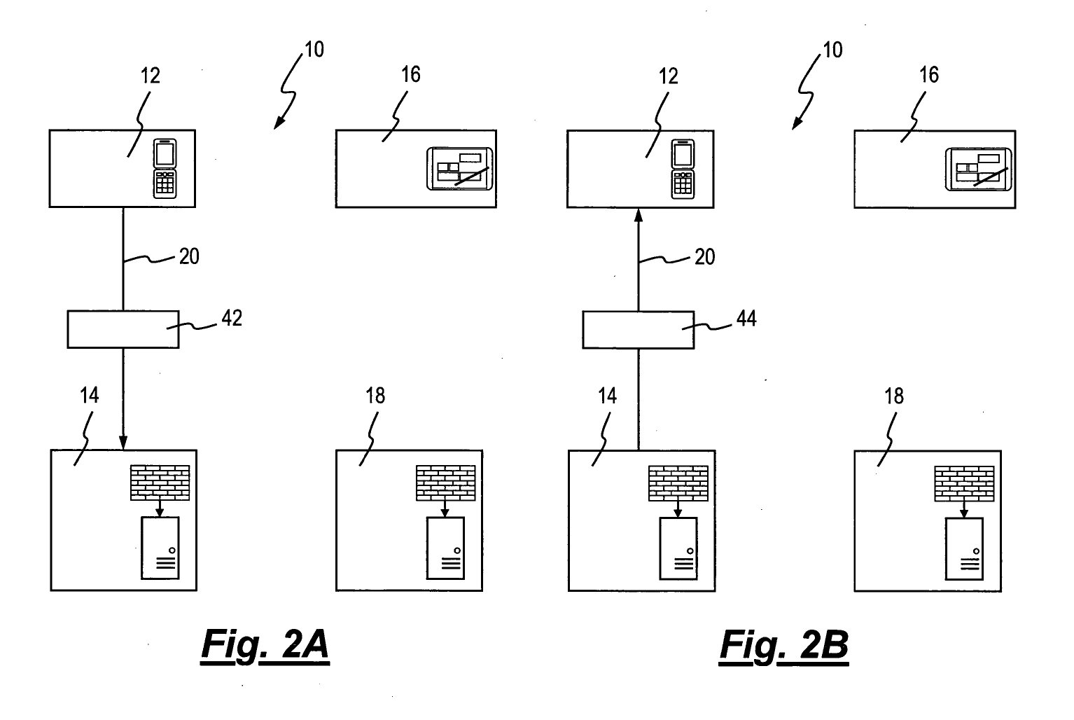

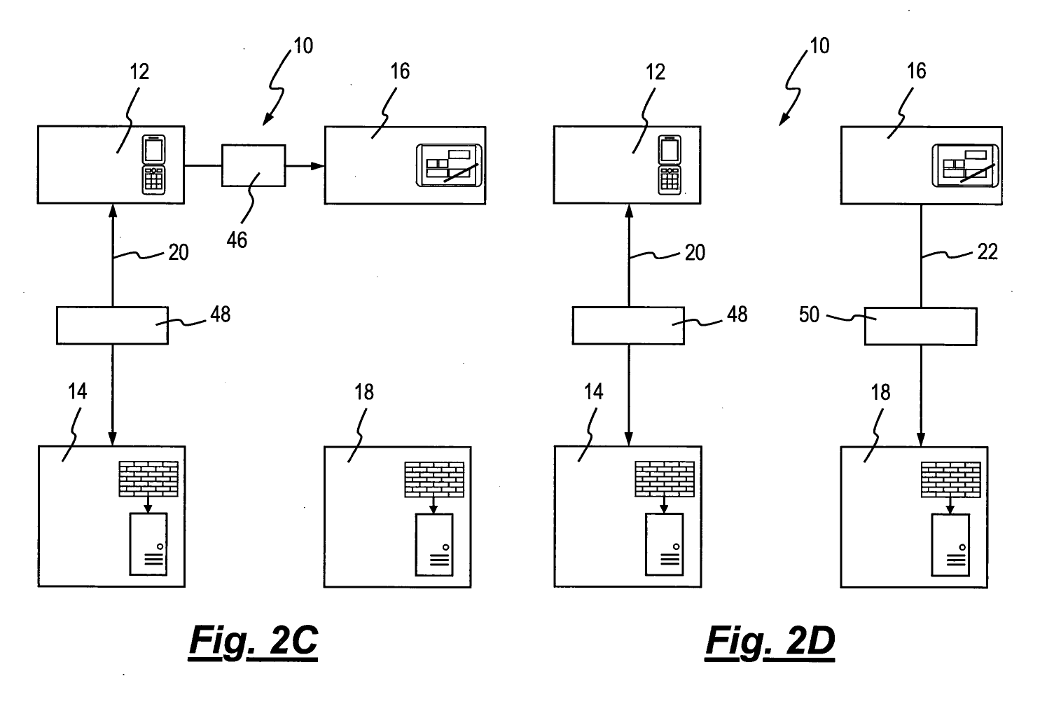

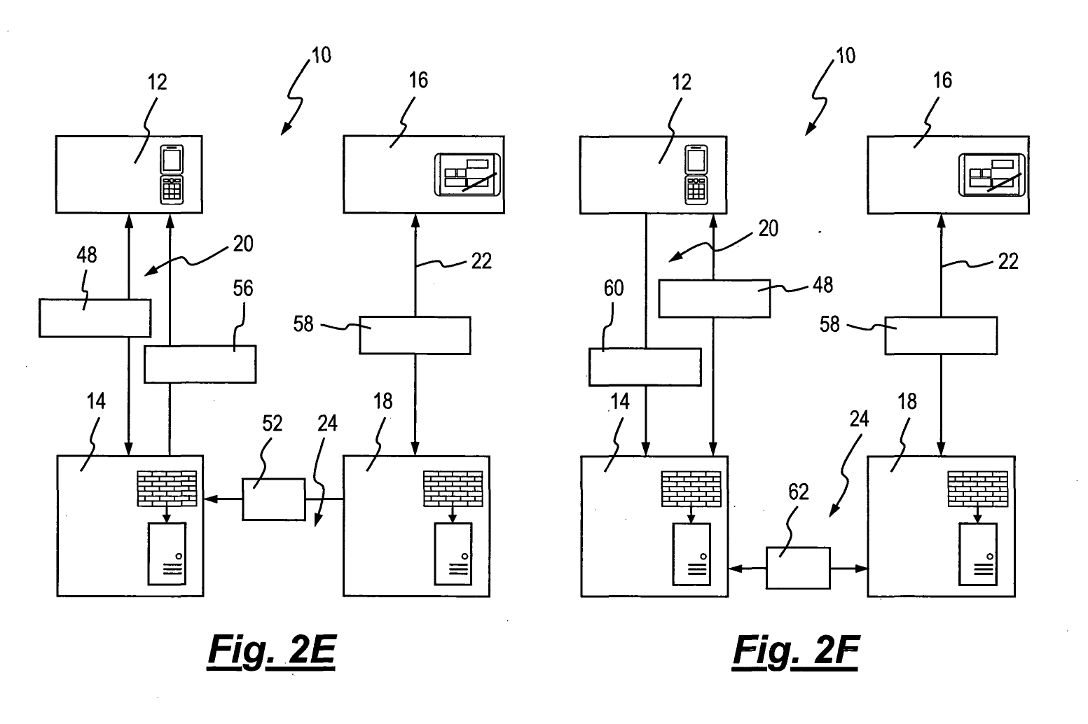

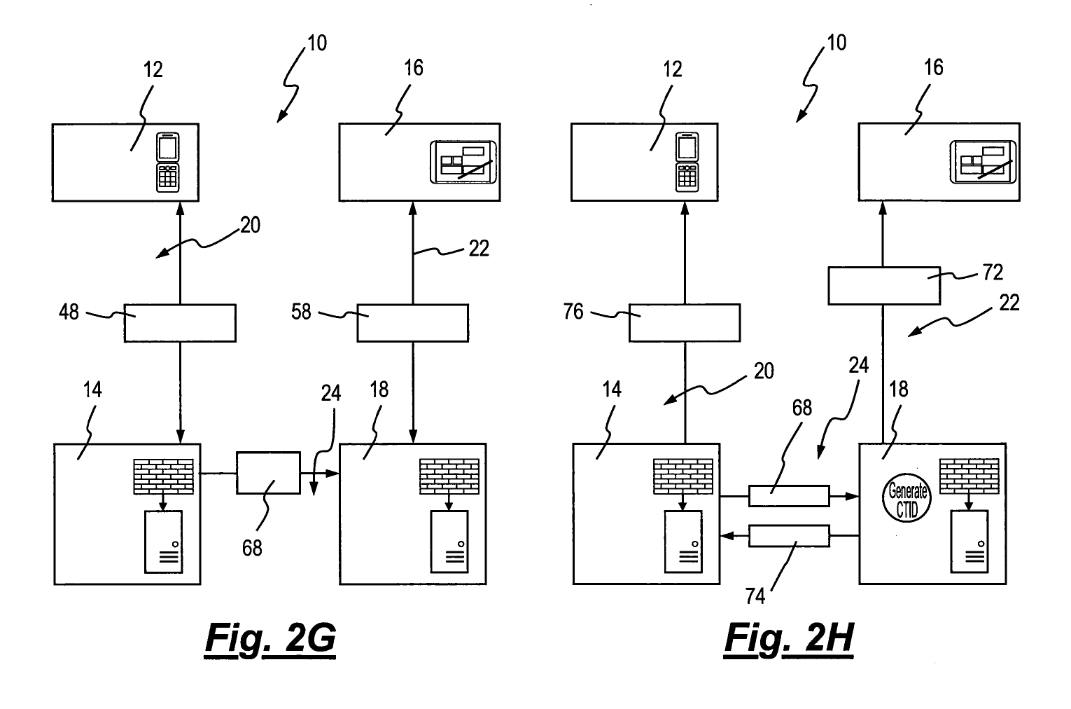

Operation of the payment handling apparatus 10 of FIG. 1 in accordance with the present invention will now be described with reference to FIGS. 2A to 2H which represent the main stages of operation of the payment handling apparatus 10. Components shown in FIGS. 2A to 2H in common with the payment handling apparatus 10 of FIG. 1 are designated with like reference numerals. The reader's attention is therefore directed to the description provided above with reference to FIG. 1 for a more detailed description of such commonly designated components.

Before the payment handling process of FIGS. 2A to 2H can start, the purchaser enrolls with the payment handling platform. More specifically the purchaser downloads a dedicated client application to his smartphone. Then the purchaser enrolls by operation of the dedicated client application with enrolment involving conventional processes such as identification of the dedicated client application by the purchaser server and vice-versa.

FIG. 2A shows a first main stage of operation in which the purchaser client 12 is operative to send a unique code request 42 to the purchaser server 14. Considering the first main stage in more detail, a purchaser wishes to buy goods or services from a vendor. The purchaser therefore goes to the vendor's point of sale and initiates the payment process by operating his smartphone which is running the dedicated client application. The client application is operative to display a dialog box on a display screen of the smartphone. The dialog box is configured to provide for reciprocal communication between the client application and the purchaser. In accordance with normal design practice for smartphone applications, the dialog box comprises touch sensitive areas which are operable by the purchaser to provide for entry of data and control of the client application by the purchaser. The purchaser actuates an appropriately designated part of the dialog box to initiate generation of the unique code request 42. The client application is then operative to form the unique code request 42. The client application has been configured to provide for communication with a server of at least one payment processing authority. For example the purchaser may have three bank accounts with different banks. The client application is therefore configured to allow the purchaser to select one of the three bank accounts and to provide for transmission of the unique code request 42 to the purchaser server 14 by way of the computer network 20 in dependence on the selection where such selection is performed. It is to be noted that there is no storage of the purchaser's bank account details in the purchaser client 12 or in the smartphone. Instead the client application is preconfigured by way of secure identification of the client application with the server or servers holding the bank account or bank accounts to which the purchaser wishes to gain access by way of a conventional digital banking software platform. Such an approach provides two factor authentication.

FIG. 2B shows a second main stage of operation in which the purchaser server 14 is operative to send a unique code 44 to the purchaser client 12. Considering the second main stage in more detail, the purchaser server 14 receives the unique code request 42 from the purchaser client 12 and generates the unique code 44 in dependence on the received unique code request 42. The unique code is alphanumeric and lacks the letters O, I, Q and Z on account of these letters being liable to confusion with other alphanumeric characters. The length of the unique code is a compromise between the requirement for uniqueness having regard to the number of simultaneous payments being handled in the wider payment handling environment and ease of handling by the payment handling apparatus. For example in smaller territories having a payment handling environment of modest size a shorter unique code, such as of three or four alphanumeric elements, may suffice to achieve uniqueness whereas in larger territories a longer unique code, such as of five or more alphanumeric elements, is typically required. A unique code of seven or more elements can be expected to suffice for much larger territories. When the unique code 44 is generated, the purchaser server 14 is operative to transmit the unique code 44 to the purchaser client 12 by way of the computer network 20.

FIG. 2C shows a third main stage of operation in which the unique code is conveyed 46 to the vendor client 16 from the purchaser client 12. Considering the third main stage in more detail and according to a first approach, the purchaser client 12 is operative to display the unique code received from the purchaser server 14 on the display screen of the purchaser's smartphone. Before proceeding further the purchaser's loyalty card is scanned by a barcode scanner comprised in the vendor's point of sale apparatus in accordance with conventional practice to accumulate reward points and perhaps also, if it is desired by the purchaser, to discount the sale price by redemption of accumulated reward points. Similarly a loyalty voucher or offer voucher can be scanned by a barcode scanner comprised in the vendor's point of sale apparatus. Then the purchaser reads the displayed unique code and verbally conveys the unique code to the vendor. The vendor then enters the unique code into the vendor client 16 such as by way of operation of a touch keypad on the vendor's computing apparatus. The purchaser client 12 and the purchaser server 14 then enter a wait state 48 as the payment handling process progresses further. According to a second approach, loyalty card information from plural vendors is stored in the purchaser's smartphone. The purchaser's smartphone is operative in dependence on WiFi reception from a WiFi transceiver present in the vendor's premises to determine the identity of the vendor and in dependence on determination of the identity of the present vendor to select the present vendor's loyalty card information from the stored loyalty card information. The purchaser's smartphone is then operative to form and display a QR code which comprises the unique code along with the selected loyalty card information. The displayed QR code is scanned by a QR code scanner comprised in the vendor's point of sale apparatus in accordance with conventional practice to thereby upload the unique code and the loyalty card information to the vendor client 16. The loyalty card information is then applied in the conventional fashion such as in respect of accumulation of reward points or discounting of the sale price by redemption of accumulated reward points. According to a third approach and where each of the purchaser's smartphone and the vendor's computing apparatus comprises near field communications apparatus, the purchaser's smartphone is operative to form electronically stored data comprising the unique code along with loyalty card information which is selected as described above with reference to the second approach. The purchaser's smartphone and the vendor's computing apparatus are then operative to wirelessly convey the electronically stored data from the purchaser's smartphone to the vendor's computing apparatus by a near field communications link. Upon receipt of the electronically stored data, the vendor's computing apparatus is operative to strip the unique code and the loyalty card information from the electronically stored data for application as described elsewhere herein.

FIG. 2D shows a fourth main stage of operation in which the unique code is transmitted from the vendor client 16 to the vendor server 18 along with details relating to the payment 50. Considering the fourth main stage in more detail, the vendor enters details relating to the payment into the vendor client 16 such as by way of operation of a touch keypad on the vendor's computing apparatus. Alternatively details relating to the payment are uploaded to the vendor client 16 by way of a scanner comprised in the vendor's point of sale apparatus which is operative to scan a barcode or QR code on goods being purchased. Scanning of the barcode or QR code on goods being purchased is done at the same time as scanning of a QR code displayed on the purchaser's smartphone according to the second approach described above. The details relating to the payment comprise the purchase price, whether or not the vendor accepts tips and typically also include, for the purposes of local vendor record keeping, identification of the goods or services being purchased. The vendor client is then operative to form a packet of data comprising the unique code, identification information for the vendor and the sum to be paid. Identification information for the vendor comprises an identification code for the vendor, the vendor's name and the vendor's logo. Thereafter the vendor client 16 is operative to provide for transmission of the packet of data comprising the unique code 50 to the vendor server 18 by way of the computer network 22. In the meantime the purchaser client 12 and the purchaser server 14 remain in the wait state 48 as the payment handling process progresses further.

FIG. 2E shows a fifth main stage of operation in which a request to pay message comprising the unique code is transmitted from the vendor server 18 to the purchaser server 14. Considering the fifth main stage in more detail, the vendor server 18 is operative to form the request to pay message such that it comprises the unique code, the sum to be paid, the vendor identification information, whether or not the vendor accepts tips, and bank information for the vendor including the sort code, the account number and the account name. The vendor server 18 then forms a packet of data comprising the request to pay message. The vendor server 18 is then operative to provide for the transmission of the packet of data 52 to the purchaser server 14. Upon receipt of the packet of data 52, the purchaser server 14 is operative to un-package the packet of data and to extract the information comprised therein. The purchaser server 14 is then operative to compare the unique code extracted from the packet of data with the unique code issued earlier to the purchaser client 12 to determine its validity. The purchaser server 14 is also operative to confirm that the purchaser's bank account contains sufficient funds to cover the purchase by comparing the purchaser's bank account balance with the sum to be paid which was extracted from the packet of data. If both of these checks are passed, the purchaser server 14 is operative to form a further packet of data comprising the sum to be paid, the vendor identification information and whether or not the vendor accepts tips. The purchaser server 14 then transmits the further packet of data 56 to the purchaser client 12, the purchaser client having been identified from the unique code. The vendor server 18 and the vendor client 16 then enter a wait state 58 as the payment handling process progresses further. The purchaser client 12 and the purchaser server 14 resume their wait state 48 as the payment handling process progresses further.

FIG. 2F shows a sixth main stage of operation involving approval of payment by the purchaser. Considering the sixth main stage in more detail, following receipt of the further packet of data 56 from the purchaser server 14, the purchaser client 12 is operative to extract the sum to be paid, the vendor identification information and whether or not the vendor accepts tips. The purchaser client 12 is further operative to display the extracted information on a display screen of the purchaser's smartphone in a dialog box which is then operated upon by the purchaser to approve the transaction and, if the vendor accepts tips, to add a tip. Thereafter the purchaser client 12 is operative to form a payment approved message 60 comprising the approved status of the transaction, the amount of the tip if any and the sum to be paid. The purchaser client 12 is operative to send the payment approved message 60 to the purchaser server 14. In the meantime the vendor server 18 and the vendor client 16 remain in their wait state 58 and the purchaser server 14 and the vendor server 18 enter wait states 62 pending approval of the transaction by the purchaser. After approval of the transaction by the purchaser the purchaser client 12 and the purchaser server 14 resume their wait state 48 pending completion of the payment.

According to another embodiment and where the sum to paid is below a predetermined level, such as £20, there is no further packet of data 56 sent by the purchaser server 14 to the purchaser client 12 and therefore no need for the purchaser to approve payment by way of the purchaser client 12. Instead payment authorisation and approval is accomplished by the purchaser server 14 alone without reference to the purchaser.

FIG. 2G shows a seventh main stage of operation during which the payment is made. Considering the seventh main stage in more detail, following receipt of the payment approved message 60 from the purchaser client 12 or following authorisation and approval by the purchaser client 12 alone (i.e. where no further packet of data 56 is sent by the purchaser server 14 to the purchaser client 12) the purchaser server 14 is operative to make the payment to the vendor server 18 in dependence on the bank information for the vendor contained in the packet of data 52 comprising the request to pay message which was received by the purchaser server 14 in the step described above with reference to FIG. 2E. Payment is made by way of a payment mechanism of conventional form between the purchaser server 14 and the vendor server 18. The purchaser server 14 then forms a payment complete message comprising the unique code, the sum paid including a tip if any and other information providing for payment traceability, such as time and date of payment, payment mechanism employed, etc. The payment complete message 68 is sent to the vendor server 18. In the meantime, the purchaser client 12 and the purchaser server 14 remain in their wait state 48 and the vendor server 18 and the vendor client 16 remain in their wait state 58.

FIG. 2H shows an eighth main stage of operation during which the payment process is completed. Considering the eighth main stage in more detail, upon receipt of the payment complete message 68, the vendor server 18 is operative to form and send a first vendor payment confirmed message 72 to the vendor client 16. The first vendor payment confirmed message 72 comprises a vendor server unique code (a CTID), which is generated upon completion of the payment by the vendor server 18, and the sum paid including the price paid and the tip if any. Upon receipt of the first vendor payment complete message 72, the vendor client 16 extracts the information from the first vendor payment complete message 72 and stores the transaction information along with vendor client local date and time. The vendor client 16 also displays the transaction information to the vendor and completes transaction processing. In addition the vendor server 18 is operative to form and send a second vendor payment confirmed message 74 to the purchaser server 14. The second vendor payment confirmed message 74 comprises the unique code, the vendor server unique code and the sum paid including the price paid and the tip if any. The vendor server 18 then records the transaction and completes transaction processing. Upon receipt of the second vendor payment complete message 74, the purchaser server 14 is operative to extract the information from the second vendor payment complete message 74 and records the transaction. The purchaser server 14 is further operative to form and send a purchaser payment confirmed message 76 to the purchaser client 12. The purchaser payment confirmed message 76 comprises the unique code, the vendor server unique code, and the price including the tip if any. Upon receipt of the purchaser payment confirmed message 76, the purchaser client 12 is operative to extract the information from the purchaser payment confirmed message 76 and to store the extracted information with the purchaser client 12 local date and time. The purchaser client 12 is also operative to display the extracted information to the purchaser and complete transaction processing.

After completion of the payment, the unique code is terminated. According to one approach the unique code is designated as expired in the clients and servers whereby a message comprising the terminated unique code is not acted upon thereafter. According to another approach the unique code is deleted from the clients and servers whereby a message comprising the now deleted unique code is not acted upon.

1. Payment handling apparatus which is operable to effect payment from a purchaser to a vendor, the payment handling apparatus comprising:
a purchaser client operable by the purchaser;
a vendor client operable by the vendor;
a purchaser server which stores bank account information of the purchaser and which is in data communication with the purchaser client; and
a vendor server which stores bank account information of the vendor and which is in data communication with the vendor client and the purchaser server, the payment handling apparatus being configured such that there is no data communication between the purchaser server and the vendor client and between the vendor server and the purchaser client,
the purchaser client being operative in dependence on purchaser operation to receive a unique code from the purchaser server,
the vendor client being operative in dependence on vendor operation to communicate the unique code and a sum to be paid to the vendor server,
the purchaser and vendor servers being in data communication to effect payment of the sum from the purchaser's bank account to the vendor's bank account in dependence on the unique code.

2. Payment handling apparatus according to claim 1 configured such that there is no direct data communication between the purchaser server and the vendor client and between the vendor server and the purchaser client.

3. Payment handling apparatus according to claim 1 configured such that there is no data communication of bank account information between the purchaser server and the vendor client and between the vendor server and the purchaser client.

4. Payment handling apparatus according to claim 1 configured such that bank account information of the purchaser is stored in the purchaser server only of the purchaser client and the purchaser server.

5. Payment handling apparatus according to claim 1 configured such that bank account information of the vendor is stored in the vendor server only of the vendor client and the vendor server.

6. Payment handling apparatus according to claim 1 configured such that bank account information of the purchaser is stored in the purchaser server only of the purchaser server, vendor client and the purchaser client.

7. Payment handling apparatus according to claim 6 configured such that the bank account information of the purchaser is stored in the purchaser server only of the purchaser server, the vendor client, the purchaser client and the vendor server.

8. Payment handling apparatus according to claim 1 configured such that the purchaser client is operative to send a unique code request to the purchaser server in dependence on purchaser operation.

9. Payment handling apparatus according to claim 8 configured such that upon receipt of the unique code request the purchaser server is operative to generate a unique code and to send the unique code to the purchaser client, the unique code then being conveyed to the vendor client.

10. (canceled)

11. Payment handling apparatus according to claim 9 configured such that the purchaser client is operative to provide the unique code to the vendor client by electronic means.

12. Payment handling apparatus according to claim 11 in which the purchaser client is configured to form a barcode comprising the unique code and to display the barcode, the displayed barcode then being received by the vendor client in dependence on the vendor client being configured to scan the barcode.

13. (canceled)

14. Payment handling apparatus according to claim 1 configured such that the vendor client is operative to communicate vendor identification information to the vendor server along with the unique code and the sum to be paid.

15. Payment handling apparatus according to claim 1 configured such that the vendor server is operative to send a request to pay message to the purchaser server, the request to pay message comprising the unique code and the sum to be paid.

16. Payment handling apparatus according to claim 15 configured such that upon receipt of the unique code comprised in the request to pay message the purchaser server is operative to match the unique code comprised in the request to pay message with a unique code generated previously by the purchaser server in response to a unique code request sent by the purchaser client to thereby authenticate the request to pay message.

17. Payment handling apparatus according to claim 1 configured such that the purchaser server is operative to send a request to pay message to the purchaser client, the request to pay message sent to the purchaser client comprising the sum to be paid and vendor identification information.

18. (canceled)

19. Payment handling apparatus according to claim 1 configured such that the unique code is terminated after payment of the sum from the purchaser's bank account to the vendor's bank account has been effected.

20. Payment handling apparatus according to claim 19 configured such that one of: the unique code is designated as expired whereby a message comprising the terminated unique code is not acted upon; and the unique code is deleted whereby a message comprising the now deleted unique code is not acted upon.

21. Payment handling apparatus according to claim 1 configured such that after payment of the sum from the purchaser's bank account to the vendor's bank account has been effected, the purchaser server is operative to send a payment complete message to the vendor server, the purchaser payment complete message comprising the unique code and the amount paid.

22. Payment handling apparatus according to claim 1 configured such that after payment of the sum from the purchaser's bank account to the vendor's bank account has been effected the vendor server is operative to send a vendor payment confirmed message to at least one of: the purchaser server; the vendor client; and the purchaser client by way of the purchaser server, the vendor payment complete message comprising a vendor server unique code and the amount paid.

23. (canceled)

24. A payment handling method which effects payment from a purchaser to a vendor, the method comprising:
receiving in a purchaser client a unique code from a purchaser server in dependence on operation of the purchaser client by the purchaser, the unique code being received by way of data communication between the purchaser client and the purchaser server, the purchaser server storing bank account information of the purchaser;
communication of the unique code and a sum to be paid from a vendor client to a vendor server in dependence on operation of the vendor client by the vendor, the unique code and the sum to be paid being communicated by way of data communication between the vendor client and the vendor server, the vendor server storing bank account information of the vendor; and
effecting payment of the sum from the purchaser's bank account to the vendor's bank account in dependence on the unique code and by way of data communication between the purchaser and vendor servers, there being no data communication between the purchaser server and the vendor client and between the vendor server and the purchaser client.

25. A computer program comprising program instructions for causing computer apparatus to perform the method according to claim 24.

26-28. (canceled)
